(19) United States
(12) Patent Application Publication
(10) Pub. No.: US 2008/0082349 A1
(43) Pub. Date: Apr. 3, 2008

(54) Using information about a financial transaction to augment information in an online social network

(76) Inventors: John W. Zackrison, Santa Clara, CA (US); Benjamin R. Weiss, Palo Alto, CA (US); Paul J. Rosenfeld, Mountain View, CA (US); Charles Shieh, Cupertino, CA (US); Uronna N. Gaillard, San Francisco, CA (US); Keyvan Rahmatian, San Francisco, CA (US); Eddy W. Wu, Cupertino, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/540,356

(22) Filed: Sep. 29, 2006

(51) Int. Cl. G06Q 10/00; G06Q 30/00

(52) U.S. Cl. 705/1

(57) ABSTRACT

A system that facilitates using information about a financial transaction to augment information in a representation of a social network. During operation, the system receives parameters for a financial transaction involving a number of entities. Next, the system determines one or more associations between the entities and the parameters. The system then uses the determined associations to augment information about entities in the representation of the social network.

### BACKGROUND

### Related Art

The present invention relates to techniques for using information about a financial transaction to augment information in a representation of an online social network.

A person typically values advice from people within their own social network over advice from people outside of their social network. For example, a person looking for a plumber might first ask family members, friends and business associates for referrals before using a third-party referral service. Once the person has a referral for a plumber, the person may choose to determine whether other people outside of their social network have used the plumber and how these people have rated the experience of using the plumber. Unfortunately, this process is time consuming.

As access to the Internet becomes more ubiquitous, interactions between people are increasingly occurring through the Internet. For example, online social networks are appearing on the Internet, which has led to the emergence of new communities, such as Zipingo, MySpace, and Friendster. These online social networks enable members to quickly obtain information from other members. For example, a member of a social network can find other members with similar personal interests (e.g., favorite music) or can find referrals for products and services from other members.

In order to use these online social networks, a person typically first joins the network. However, upon joining an online social network, a new user has no connections to friends, family, or business associates. Hence, the new user must search for friends, family, and business associates who are already part of the social network. The new user can typically find these people by searching for a name, an email address, or other information that can identify a specific member the new user is trying to find. After identifying members of the social network that the new user knows, the new user typically requests permission to connect to the member of the social network. If the member authorizes the connection, a link is created between the new user and the member. Once the new user has created connections to other members of the social network, the new user can query the social network to obtain different types of information. For example, the new user can post a message on a bulletin board for members in the social network asking for referrals to plumbers. Unfortunately, this process is burdensome and there is no way to verify that a member of the person's social network has actually used the referred plumber.

### SUMMARY

One embodiment of the present invention provides a system that facilitates using information about a financial transaction to augment information in a representation of a social network. During operation, the system receives parameters for a financial transaction involving a number of entities. Next, the system determines one or more associations between the entities and the parameters. The system then uses the determined associations to augment information about entities in the representation of the social network.

In a variation on this embodiment, while using an association to augment information about an entity, the system uses the association to add information to a profile for the entity, wherein the profile is contained in the representation of the social network.

In a further variation, the profile contains demographic information about the entity.

In a variation on this embodiment, while using an association to augment the information about the entities, the system uses the association to generate a link between entities in the representation of the social network, wherein the link is associated with information about the financial transaction.

In a further variation, the information associated with the link can include an item involved in the financial transaction, an amount of money involved in the financial transaction, a service involved in the financial transaction, and any other information associated with the financial transaction.

In a further variation, if two entities in the social network have not previously engaged in a financial transaction, the system facilitates the manual creation of a link between the two entities.

In a further variation, the system generates a visualization of the social network, wherein the visualization includes nodes and links between the nodes, wherein a node is associated with an entity in the social network.

In a variation on this embodiment, while using an association to augment information about an entity, the system uses the association to verify information in a profile for the entity involved in the financial transaction, wherein the profile is contained in the representation of the social network.

In a variation on this embodiment, the system uses information about an entity in another social network to augment information about a corresponding entity in the social network.

In a variation on this embodiment, the system uses information about an entity in the social network to augment information about a corresponding entity in another social network.

In a variation on this embodiment, the financial transaction can include a credit card transaction, a checking account transaction, a brokerage account transaction, or any other transaction that involves a financial instrument or account.

In a variation on this embodiment, the social network can be queried to determine, one or more shared attributes between entities in the social network, a price for a product or for a service which was paid by an entity in the social network, a referral for a product or for a service which was used by an entity in the social network, market research data based on financial transactions made by entities in the social network, or any other query based on parameters associated with financial transactions within the social network.

In a variation on this embodiment, prior to receiving the financial transaction, the system determines whether an entity involved in the financial transaction has authorized the publication of information associated with the financial transaction. If so, the system requests information about the financial transaction.

### BRIEF DESCRIPTION OF THE FIGURES

FIG. 1A presents a block diagram illustrating a financial transaction involving an aggregator which uses information about financial transactions to augment information about entities in a social network in accordance with an embodiment of the present invention.

FIG. 1B presents a block diagram of an aggregator in accordance with an embodiment of the present invention.

FIG. 2A presents a block diagram of an exemplary social network in accordance with an embodiment of the present invention.

FIG. 2B presents a block diagram of an exemplary view of the exemplary social network illustrated in FIG. 2A in accordance with an embodiment of the present invention.

FIG. 2C presents a block diagram of another exemplary view of the exemplary social network illustrated in FIG. 2A in accordance with an embodiment of the present invention.

FIG. 3 presents a flow chart illustrating the process of using information about a financial transaction to augment information in a representation of a social network in accordance with an embodiment of the present invention.

FIG. 4 presents a flow chart illustrating the process of determining whether information about the financial transaction can be retrieved in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention uses information about financial transactions to augment information about entities in a social network. In this embodiment, the representation of the social network can be built based on financial transactions between entities. Hence, instead of manually filling out a profile for a social network and manually making connections to entities within the social network, the present invention automatically fills out or augments profiles, and makes connections between entities using information from financial transactions.

### Social Network Aggregator

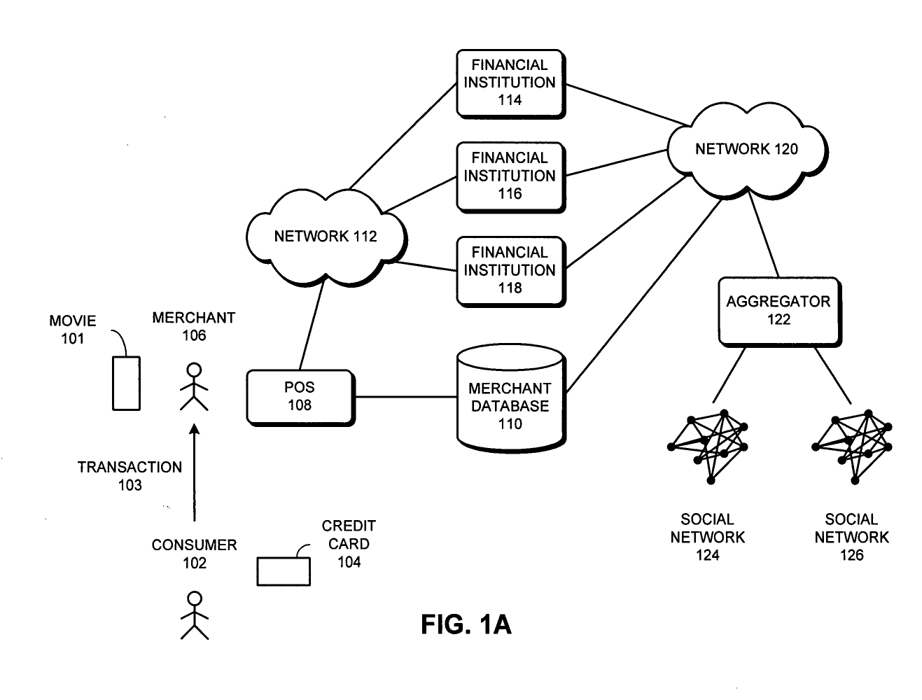

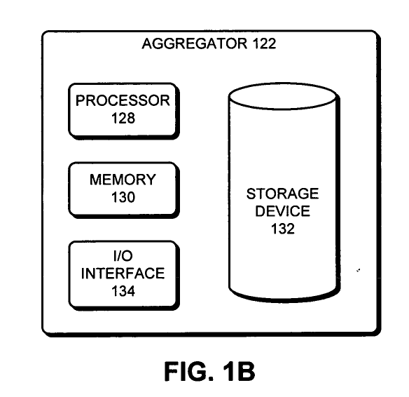

FIG. 1B presents a block diagram of an aggregator 122 in accordance with an embodiment of the present invention. Aggregator 122 includes processor 128, memory 130, storage device 132, and I/O interface 134. Processor 128 can generally include any type of processor, including, but not limited to, a microprocessor, a mainframe computer, a digital signal processor, a personal organizer, a device controller and a computational engine within an appliance. Memory 130 can include any type of memory, including but not limited to, dynamic random access memory (DRAM), static random access memory (SRAM), flash memory, and read only memory (ROM). Storage device 132 can include any type of non-volatile storage device that can be coupled to a computer system. This includes, but is not limited to, magnetic, optical, and magneto-optical storage devices, as well as storage devices based on flash memory and/or battery-backed up memory. I/O interface 134 can include any type of interface that provides connectivity between a computer system and an I/O device including, but not limited to, a wireless network device, an Ethernet device, a phone network device, a storage device, and a memory system.

In one embodiment of the present invention, I/O interface 134 receives parameters for a financial transaction involving a number of entities. In this embodiment, processor 129 uses the received parameters to determine one or more associations between the entities and the parameters, and uses the determined associations to augment information about entities in the representation of the social network; and a storage device which stores the augmented information about the entities in the representation of the social network.

FIG. 1A presents a block diagram illustrating a financial transaction involving aggregator 122 which uses information about financial transactions to augment information about entities in a social network in accordance with an embodiment of the present invention. In FIG. 1A, consumer 102 purchases movie 101 from merchant 106 using credit card 104. In FIG. 1A, this transaction is represented by financial transaction 103. During this transaction, merchant 106 uses point-of-sale (POS) device 108 to determine whether consumer 102 is authorized to make the purchase using credit card 104.

Note that although financial transaction 103 is illustrated as involving a credit card, any financial instrument can be used to complete the transaction. Hence, the financial instrument can include, but is not limited to, a credit card, a checking account, a brokerage account, or any other financial instrument.

Next, POS device 108 contacts a financial institution to determine whether consumer 102 is authorized to use credit card 104 for the purchase. In this example, POS device 108 contacts financial institution 114 through network 112. Note that financial institutions 114-118 can include banks, credit card processors, credit card clearing houses, or any other financial institution that can authorize a purchase that involves a financial instrument.

Financial institution 114 then determines whether consumer 102 is authorized to use credit card 104 to make the purchase from merchant 106 and sends the response back through network 112 to POS device 108. If financial institution 114 has authorized the transaction, POS device 108 causes the transaction to be recorded in merchant database 110 and completes the transaction with consumer 102.

Note that the credit card authorization process described above is used for illustrative purposes only and can be modified without changing the operation of the present invention.

In one embodiment of the present invention, if an entity involved in the financial transaction has authorized the publication of information associated with the financial transaction, an aggregator requests information about the financial transaction. In one embodiment of the present invention, the aggregator is a financial institution. For example, aggregator 122 can be a financial institution which can determine whether consumer 102 is authorized to use credit card 104 to make a purchase. Hence, instead of contacting financial institution 114, POS device 108 can contact aggregator 122 directly.

In one embodiment of the present invention, aggregator 122 receives a notification that the financial transaction has occurred. In response to the notification, aggregator 122 determines whether an entity involved in the financial transaction has authorized the publication of information associated with the financial transaction. If so, aggregator 122 requests information about the financial transaction.

In one embodiment of the present invention, aggregator 122 receives information about the financial transaction from merchant database 110 through network 120. In another embodiment of the present invention, aggregator 122 receives information about the financial transaction from a financial application used by consumer 102 through network 120. In another embodiment of the present invention, aggregator 122 receives information about the financial transaction from financial institution 114 through network 120.

Note that networks 112 and 120 can generally include any type of wired or wireless communication channel capable of coupling together computing nodes. This includes, but is not limited to, a local area network, a wide area network, or a combination of networks. In one embodiment of the present invention, networks 112 and 120 include the Internet. In one embodiment of the present invention, network 112 and 120 can be the same network.

In one embodiment of the present invention, aggregator 122 uses the information from the financial transaction to augment information about entities in a social network. In this example, aggregator 122 extracts information about the entities involved in the financial transaction from the parameters of the financial transaction. In one embodiment of the present invention, the parameters associated with the financial transaction can include, but are not limited to: an item involved in the financial transaction, an amount of money involved in the financial transaction, a service involved in the financial transaction, and any other information associated with the financial transaction. For example, the parameters of the financial transaction illustrated in FIG. 1A can include, but are not limited to, the price of movie 101 and a merchant identifier (ID).

In one embodiment of the present invention, after receiving the information about the financial transaction, aggregator 122 creates an association between entities involved in the financial transaction and the parameters of the financial transaction. For example, the associations can include, but are not limited to, associations between: consumer 102 and movie 101, consumer 102 and the genre of the movie 101, consumer 102 and merchant 106, merchant 106 and movie 101, merchant 106 and the genre of movie 101, consumer 102 and the amount of money involved in the transaction, and merchant 106 and the amount of money involved in the transaction. Hence, in one embodiment of the present invention, aggregator 122 determines one or more associations between the entities and the parameters, and creates one or more associations which are used to augment information about entities in the social network.

Aggregator 122 can then use the associations in one of several ways. In one embodiment of the present invention, aggregator 122 uses an association to add information to a profile for an entity which is involved in the financial transaction, wherein the profile is part of the representation of the social network. In one embodiment of the present invention, the profile contains demographic information about the entity. For example, a profile for a person can contain information about the age, the sex, the height, hobbies, favorite music, and favorite movies of the person. In this example, aggregator 122 automatically fills out the profile for consumer 102 within the social network using the information contained in the associations. For example, aggregator 122 can add movies to a list of hobbies for the user. Similarly, aggregator 122 can add movie 101 to a list of favorite movies for consumer 102.

In another embodiment of the present invention, aggregator 122 uses an association to generate a link between entities in the representation of the social network, wherein the link is associated with information about the financial transaction. For example, aggregator 122 creates a link between consumer 102 and merchant 106. In one embodiment of the present invention, if two entities in the social network have not previously engaged in a financial transaction, a link can be manually created between the two entities. For example, consumer 102 and a friend of consumer 102 can be linked together even if they have not engaged in a financial transaction that aggregator 122 has observed.

In another embodiment of the present invention, aggregator 122 uses an association to verify information in a profile for the entity involved in the financial transaction, wherein the profile is contained in the representation of the social network. Profiles in social networks are typically filled out by the user and there is no way to verify if the user is being truthful when filling out the profile. For example, a profile for a user in the social network can indicate that the user likes to watch movies, even if the user has not rented a movie or has not seen a movie in a theater for over a year. The associations generated by aggregator 122 can be used to verify information in a profile for the user. For example, aggregator 122 can verify the profile of consumer 102 by indicating that the consumer recently purchased movie 101.

In one embodiment of the present invention, the associations generated by aggregator 122 are stored within aggregator 122. In this embodiment, the associations generated by aggregator 122 create a social network. Information from this social network can then be combined with information from another social network. For example, information from a social network based purely on financial transactions (e.g., one that is generated by aggregator 122) can be combined with information from a purely social network (e.g., MySpace).

In another embodiment of the present invention, the associations generated by aggregator 122 are stored in aggregator 122, but are not used to create a social network. In this embodiment, an existing social network queries aggregator 122 to retrieve updated (or verified) information about entities within the social network

In one embodiment of the present invention, information about an entity in a first social network can be used to augment information about a corresponding entity in the second social network. In another embodiment of the present invention, information about an entity in the second social network can be used to augment information about a corresponding entity in the first social network.

In one embodiment of the present invention, a social network can be queried to determine: one or more shared attributes between entities in the social network, a price paid for a product or for a service by an entity in the social network, a referral for a product or for a service which was used by an entity in the social network, market research data based on financial transactions made by entities in the social network, or any other query based on parameters associated with financial transactions within the social network. For example, consumer 102 can query the social network to identify other entities that also purchased or rented the movie. Similarly, consumer 102 can query the social network to determine the percentage of income that was spent on purchasing movies by other entities in the social network that also purchased movie 101. Furthermore, consumer 102 can query the social network to determine where the friends of consumer 102 bought movies.

### Visualization

In one embodiment of the present invention, a visualization of the social network is generated, wherein the visualization includes nodes and links between the nodes, wherein a node is associated with an entity in the social network.

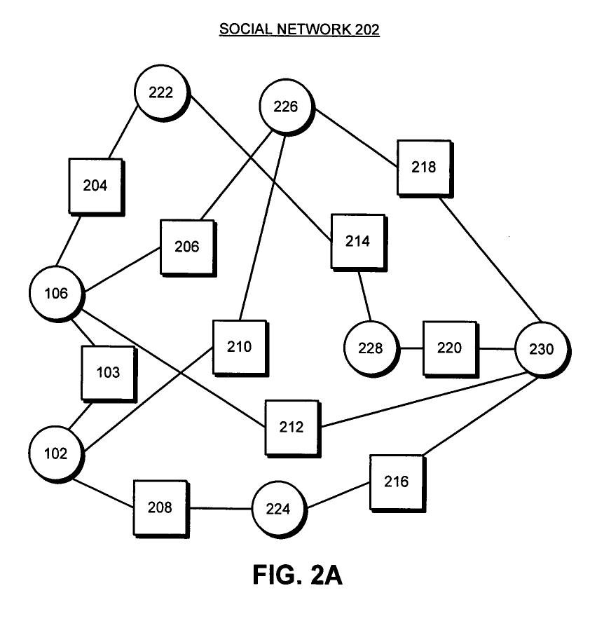

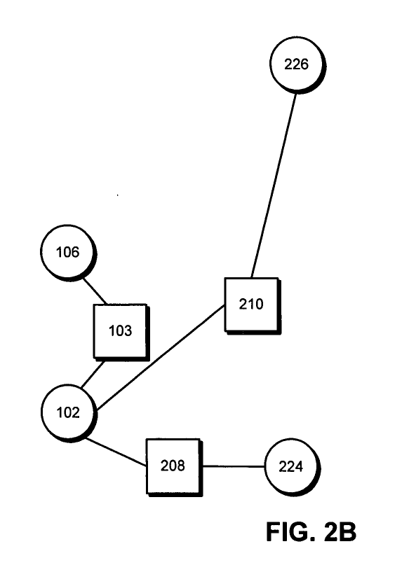

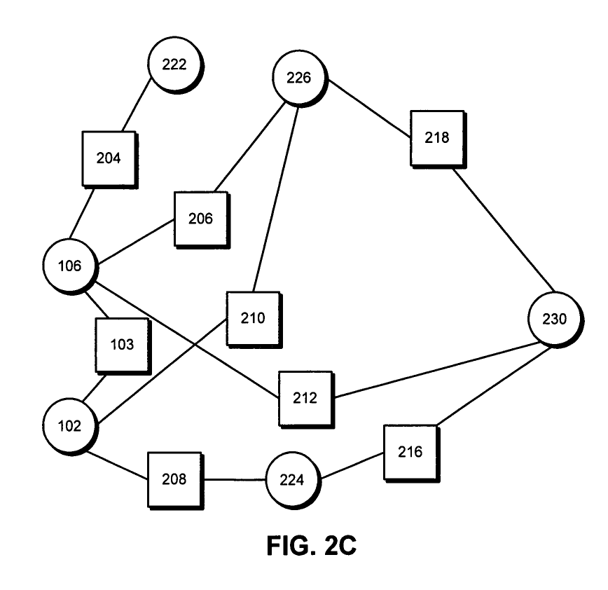

FIG. 2A presents a block diagram of an exemplary social network 202 which illustrates entities 102, 106, and 222-230, and transactions 103, and 204-218 in accordance with an embodiment of the present invention. In one embodiment of the present invention, the entities can include, but are not limited to, persons, financial institutions, or businesses. As described in reference to FIG. 1A above, consumer 102 is related to merchant 106 by transaction 103 (i.e., purchase of movie 101). Social network 202 also illustrates other entities and transactions.

In one embodiment of the present invention, each transaction node can contain one or more transactions between two entities.

In one embodiment of the present invention, the view for social network 202 can be modified to display a subset of entities and transactions. For example, the view can be modified to show only entities that are one transaction removed from consumer 102. FIG. 2B illustrates a block diagram of this view. Similarly, the view can be modified to show only entities that are two transactions removed consumer 102. FIG. 2C illustrates a block diagram of this view.

In one embodiment of the present invention, the default view of the social network is a view which displays only entities one transaction removed from the user who is viewing the social network. For example, consumer 102 only sees the transactions displayed in FIG. 2B. In this embodiment, if consumer 102 wants to determine from which entity merchant 106 purchases movies that merchant 106 resells, consumer 102 can click on merchant 106 in FIG. 2A. For example, the information stored in social network 200 might indicate that entity 222 sold merchant 106 movies in transaction 204.

In one embodiment of the present invention, clicking on an entity within the social network generates a new view wherein the selected entity is the center of the social network. For example, if a user clicks on merchant 106, the view of the social network is recentered around merchant 106. Note that when the view is recentered, the default view (e.g., displaying entities one transaction removed from merchant 106) or a user-specified view can be used.

In one embodiment of the present invention, if the details of a transaction have been made public or is viewable by a user making the query, clicking on a transaction causes the details of the transaction to be displayed. If the transaction is not made public, then the details are not displayed, however, a summary of the transaction can be displayed.

In one embodiment of the present invention, all entities involved in a financial transaction need to give permission to publicize the details of a transaction before the transaction can be viewed by a user. For example, merchant 106 and consumer 102 both need to give permission to publicize transaction 103 in order for other entities in the social network to view the details of transaction 103.

In one embodiment of the present invention, a specified subset of entities involved in a financial transaction need to give permission to publicize the details of a transaction before the transaction can be viewed by a user. For example, only consumer 102 needs to give permission to publicize transaction 103 in order for other entities in the social network to view the details of transaction 103.

In one embodiment of the present invention, if the details of the financial transaction are not public, a request can be made to the entities involved in the transaction to make the details available for viewing.

In one embodiment of the present invention, if a first entity has not engaged in a financial transaction with a second entity, the first entity can view financial transactions that involved the second entity if the second entity gives permission to the first entity to view financial transactions. For example, consumer 102 can allow a friend to view all or to view a subset of transactions involving consumer 102.

In one embodiment of the present invention, an entity in the social network can modify the details of a transaction in which the entity was involved. For example, after purchasing the movie from merchant 106, consumer 102 can add information to the transaction that rates the experience of making a purchase from merchant 106.

### SUMMARY

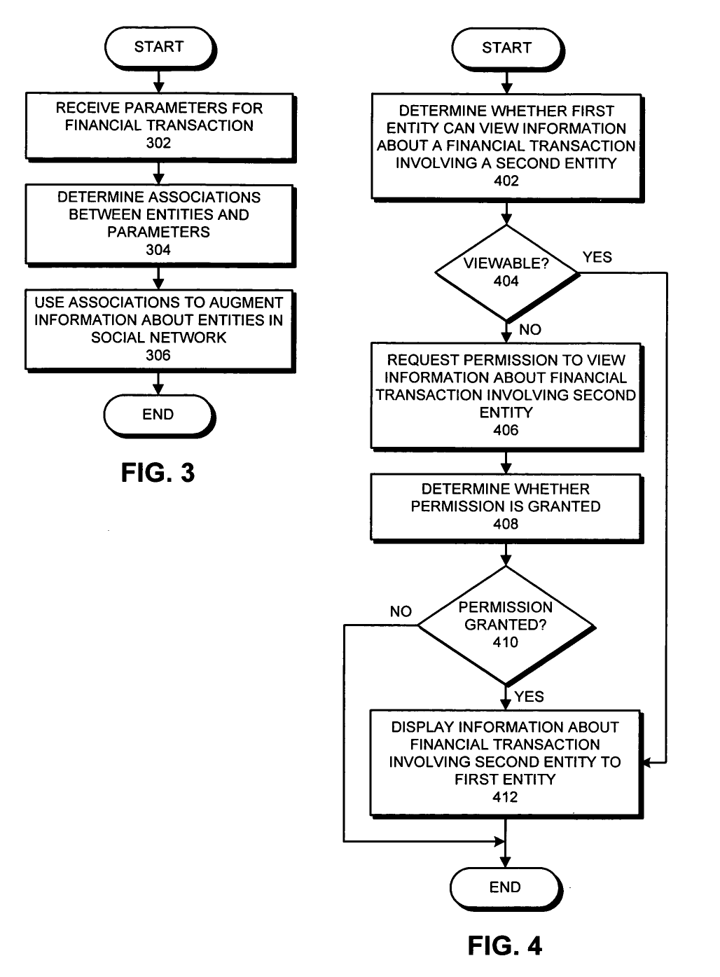

FIG. 3 presents a flow chart illustrating the process of using information about a financial transaction to augment information in a representation of a social network in accordance with an embodiment of the present invention. The process begins when the system receives parameters for a financial transaction involving a number of entities (step 302). Next, the system determines one or more associations between the entities and the parameters (step 304). The system then uses the one or more associations to augment information about entities in the representation of the social network (step 306).

FIG. 4 presents a flow chart illustrating the process of determining whether information about the financial transaction can be retrieved in accordance with an embodiment of the present invention. The process begins when the system determines whether a first entity can view information about a financial transaction involving a second entity (step 402). If so (step 404—yes), the system displays information about the financial transaction involving the second entity to the first entity (step 412). Otherwise (step 404—no), the system requests permission to view information about the financial transaction involving the second entity (step 406).

Next, the system determines whether the second entity granted permission to the first entity to view information about the financial transaction involving the second entity (step 408). If so (step 410—yes), the system displays information about the financial transaction involving the second entity to the first entity (step 412).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using information about a financial transaction to augment information in a representation of a social network, comprising:
receiving parameters for a financial transaction involving a number of entities;
determining one or more associations between the entities and the parameters; and
using the determined associations to augment information about entities in the representation of the social network.

2. The method of claim 1, wherein using an association to augment information about an entity involves using the association to add information to a profile for the entity, wherein the profile is contained in the representation of the social network.

3. The method of claim 2, wherein the profile contains demographic information about the entity.

4. The method of claim 1, wherein using an association to augment the information about the entities involves using the association to generate a link between entities in the representation of the social network, wherein the link is associated with information about the financial transaction.

5. The method of claim 4, wherein the information associated with the link can include:
an item involved in the financial transaction;
an amount of money involved in the financial transaction;
a service involved in the financial transaction; and
any other information associated with the financial transaction.

6. The method of claim 4, wherein if two entities in the social network have not previously engaged in a financial transaction, the method further comprises facilitating manual creation of a link between the two entities.

7. The method of claim 4, wherein the method further comprises generating a visualization of the social network, wherein the visualization includes nodes and links between the nodes, wherein a node is associated with an entity in the social network.

8. The method of claim 1, wherein using an association to augment information about an entity involves using the association to verify information in a profile for the entity involved in the financial transaction, wherein the profile is contained in the representation of the social network.

9. The method of claim 1, wherein the method further comprises using information about an entity in another social network to augment information about a corresponding entity in the social network.

10. The method of claim 1, wherein the method further comprises using information about an entity in the social network to augment information about a corresponding entity in another social network.

11. The method of claim 1, wherein the financial transaction can include:
a credit card transaction;
a checking account transaction;
a brokerage account transaction, or
any other transaction that involves a financial instrument or account.

12. The method of claim 1, wherein the social network can be queried to determine:
one or more shared attributes between entities in the social network;
a price for a product or for a service which was paid by an entity in the social network;
a referral for a product or for a service which was used by an entity in the social network;
market research data based on financial transactions made by entities in the social network; or
any other query based on parameters associated with financial transactions within the social network.

13. The method of claim 1, wherein prior to receiving the financial transaction, the method further comprises:
determining whether an entity involved in the financial transaction has authorized the publication of information associated with the financial transaction; and
if so, requesting information about the financial transaction.

14. A computer-readable storage medium storing instructions that when executed by a computer cause the computer to perform a method for using information about a financial transaction to augment information in a representation of a social network, comprising:
receiving parameters for a financial transaction involving a number of entities;
determining one or more associations between the entities and the parameters; and
using the determined associations to augment information about entities in the representation of the social network.

15. The computer-readable storage medium of claim 14, wherein using an association to augment information about an entity involves using the association to add information to a profile for the entity, wherein the profile is contained in the representation of the social network.

16. The computer-readable storage medium of claim 15, wherein the profile contains demographic information about the entity.

17. The computer-readable storage medium of claim 14, wherein using an association to augment the information about the entities involves using the association to generate a link between entities in the representation of the social network, wherein the link is associated with information about the financial transaction.

18. The computer-readable storage medium of claim 17, wherein the information associated with the link can include:
an item involved in the financial transaction;
an amount of money involved in the financial transaction;
a service involved in the financial transaction; and
any other information associated with the financial transaction.

19. The computer-readable storage medium of claim 17, wherein if two entities in the social network have not previously engaged in a financial transaction, the method further comprises facilitating the manual creation of a link between the two entities.

20. The computer-readable storage medium of claim 17, wherein the method further comprises generating a visualization of the social network, wherein the visualization includes nodes and links between the nodes, wherein a node is associated with an entity in the social network.

21. The computer-readable storage medium of claim 14, wherein using an association to augment information about an entity involves using the association to verify information in a profile for the entity involved in the financial transaction, wherein the profile is contained in the representation of the social network.

22. The computer-readable storage medium of claim 14, wherein the method further comprises using information about an entity in another social network to augment information about a corresponding entity in the social network.

23. The computer-readable storage medium of claim 14, wherein the method further comprises using information about an entity in the social network to augment information about a corresponding entity in another social network.

24. The computer-readable storage medium of claim 14, wherein the financial transaction can include:
a credit card transaction;
a checking account transaction;
a brokerage account transaction, or
any other transaction that involves a financial instrument or account.

25. The computer-readable storage medium of claim 14, wherein the social network can be queried to determine:
one or more shared attributes between entities in the social network;
a price for a product or for a service which was paid by an entity in the social network;
a referral for a product or for a service which was used by an entity in the social network;
market research data based on financial transactions made by entities in the social network; or
any other query based on parameters associated with financial transactions within the social network.

26. The computer-readable storage medium of claim 14, wherein prior to receiving the financial transaction, the method further comprises:
determining whether an entity involved in the financial transaction has authorized the publication of information associated with the financial transaction; and
if so, requesting information about the financial transaction.

27. An apparatus that facilitates using information about a financial transaction to augment information in a representation of a social network, comprising:
an I/O interface which receives parameters for a financial transaction involving a number of entities; and
a processor which is configured to through programming to use the received parameters to determine one or more associations between the entities and the parameters, and to use the determined associations to augment information about entities in the representation of the social network; and
a storage device which stores the augmented information about the entities in the representation of the social network.

28. A system that facilitates using information about a financial transaction to augment information in a representation of a social network, comprising:
a financial transaction processor which receives a financial source used to fulfill a financial transaction, wherein the financial transaction processor transmits parameters for the financial transaction involving a number of entities to a financial institution;
the financial institution processor which processes the parameters for the financial transaction to determine whether the financial transaction can be fulfilled and transmits the parameters for the financial transaction to an aggregator;
the aggregator which determines one or more associations between the entities and the parameters and uses the determined associations to augment information about entities in the representation of the social network.

29. The system of claim 28, wherein while augmenting the information about the entities, the aggregator uses the association to add information to a profile for the entity, wherein the profile is contained in the representation of the social network.

30. The system of claim 29, wherein the profile contains demographic information about the entity.

31. The system of claim 28, wherein while augmenting the information about the entities, the aggregator uses the association to generate a link between entities in the representation of the social network, wherein the link is associated with information about the financial transaction.

32. The system of claim 28, wherein while augmenting the information about the entities, the aggregator uses the association to verify information in a profile for the entity involved in the financial transaction, wherein the profile is contained in the representation of the social network.

33. The system of claim 28, wherein the aggregator is a financial institution.

34. The system of claim 28, wherein the aggregator is a third-party aggregator that collects information about financial transactions to augment information in a representation of a social network.

35. The system of claim 28, further comprising a merchant system which stores a second set of parameters for the financial transaction, wherein the merchant system transmits the second set of parameters for the financial transaction to the aggregator.

36. The system of claim 35, wherein the second set of parameters can include:
a description of items involved in the financial transaction;
a description of services involved in the financial transaction;
information about the entities involved in the transaction; and
any other information associated with the financial transaction.

37. The system of claim 28, wherein the parameters can include:
an item involved in the financial transaction;
an amount of money involved in the financial transaction;
a service involved in the financial transaction; and
any other information associated with the financial transaction.

38. The system of claim 28, wherein the financial transaction can include:
a credit card transaction;
a checking account transaction;
a brokerage account transaction, or
any other transaction that involves a financial instrument or account.
